(19) United States
(12) Patent Application Publication
(10) Pub. No.: US 2004/0140270 A1
(43) Pub. Date: Jul. 22, 2004

(54) Liquid purification method and apparatus

(76) Inventor: Philip Andrew Simmons, Alcester (GB)

Correspondence Address: Sten Erik Hakanson, Patent Attorney, IMI Cornelius Inc., One Cornelius Place, Anoka, MN, 55303-6234, US

(21) Appl. No.: 10/349,002

(22) Filed: Jan. 21, 2003

(51) Int. Cl. B01D 35/18

(52) U.S. Cl. 210/774; 210/184

(57) ABSTRACT

A method and apparatus for purifying water by employing steam generated by heating water in a lower section of a container to heat water in an upper section of the container. The lower section is separated from the upper section by a filter. A pressure differential is created across the filter such that a portion of the steam forms a steam pocket below the filter and the remaining portion passes through the filter to heat the water in the upper section. A microprocessor control system is operable to control heating of the water in the lower section and withdrawal of purified water from the upper section to maintain the size of the steam pocket between upper and lower limits.

### FIELD OF THE INVENTION

This invention relates to a method and apparatus for the purification of liquids, and particularly, but not exclusively to the purification of water.

### BACKGROUND OF THE INVENTION

It is well known to render water safer by boiling or distillation or filtration. However, boiling and distillation are energy intensive methods. Moreover, mere boiling will not remove solids and distillation in particular tends to lead to the removal of all trace minerals that can be undesirable. Filtration requires frequent filter replacement in order to avoid the filter itself acting as a breeding ground for micro-organisms and thus actually increasing their population in the liquid. Other purification techniques are known such as reverse osmosis but often use a lot of water.

### SUMMARY OF THE INVENTION

It is an object of this invention to mitigate these disadvantages.

It is a further desired object of this invention to provide a method of improving water quality and an apparatus for carrying out the method to provide a supply of purified water for any desired end use.

It is yet another preferred object of this invention to provide a method of improving water quality and an apparatus for carrying out the method that is relatively simple to operate.

It is a still further object of the present invention to provide a method of improving water quality and an apparatus for carrying out the method that may use less water than existing techniques such as reverse osmosis.

Other objects and advantages of the invention will be apparent from the description hereinafter.

According to one aspect of the invention, there is provided a liquid purification method which comprises providing a container having a lower section and an upper section separated by a filter, supplying liquid to the lower section, heating the liquid in the lower section to produce a vapour for passage through the filter, wherein a pressure differential is generated across the filter between the lower section and the upper section such that a portion of the vapour creates a pocket of vapour in the lower section below the filter and the remaining portion passes through the filter and is at least partially condensed in the upper section, and controlling the size of the vapour pocket while maintaining a volume of liquid to be heated in the lower section, and withdrawing liquid from the upper section.

While the invention is applicable to the processing of liquids other than water, it is believed that it is in the field of water purification that the greatest use and advantage will lie, and the invention will accordingly hereinafter be described with reference to water alone.

By this invention, the water in the upper section above the filter is heated by steam generated in the lower section that passes through the filter and condenses in the water above the filter. In this way, the water above the filter is heated to an elevated temperature and kept hot enough to kill any bacteria by the condensation of steam passing through the filter. Moreover, the filter itself is maintained substantially sterile since it is bathed in steam. The resulting purified water in the upper section can be drawn of for immediate use and/or stored in a reservoir for later use. As a result, the invention requires the use of less energy than a pure distillation process since only the water below the filter needs to be converted to steam and then re-condensed to heat the water above the filter without directly heating the water above the filter.

In a preferred arrangement, the method includes positioning a heater in the lower section for directly heating the water below the filter and controlling the size of the steam pocket below the filter so the heater is covered by the water. As a result, overheating of the heater is prevented reducing the risk of premature failure of the heater.

The size of the steam pocket may be controlled in various ways. The principal way is to match the flow of incoming water to the lower section to the mass flow through the filter once a desired size of steam pocket has been achieved.

The rate of mass flow through the filter is in turn dependent on the pressure differential across the filter and this can be controlled by adjusting the power of the heater to alter the pressure below the filter. For example, increasing the power of the heater accelerates boiling of the water in the lower section and thus the rate of steam generation which in turn increases the pressure below the filter. Similarly, reducing the power of the heater slows down boiling of the water in the lower section and thus the rate of steam generation which in turn reduces the pressure below the filter. Alternatively or additionally, the pressure differential across the filter can be controlled by lowering the pressure above and/or below the filter, for example by appropriate valves.

The invented method has application to the production of purified water in the upper section by both batch and continuous processes. In a batch process, the container may be initially filled with water to an upper level in the upper section and, when the water in the upper section is heated to a pre-determined temperature by steam passing through the filter from the lower section, the water in the upper section may be drawn off to a lower level at which water is introduced to the lower section. For such operation, the incoming water flow is on/off in dependence on upper and lower levels of water in the upper section and the size of the steam pocket may be controlled between upper and lower limits to accommodate the transfer of water in the form of steam vapour passing through the filter from the lower section to the upper section and ensure the heating element remains covered by water in the lower section.

In a continuous process, the container may be initially filled to a pre-determined level in the upper section and, when the water in the upper section is heated to a pre-determined temperature by steam passing through the filter from the lower section, the water in the upper section may be drawn off and water introduced to the lower section. For such operation, the incoming water flow is continuous in dependence on the rate water is drawn off from the upper section and the size of the steam pocket may again be controlled between upper and lower limits to accommodate the transfer of water in the form of steam vapour passing through the filter from the lower section to the upper section and ensure the heating element remains covered by water in the lower section.

According to another aspect of the invention, there is provided apparatus for carrying out the method comprising a container having a lower section and an upper section separated by a filter, an inlet for supplying liquid to the lower section, an outlet for withdrawing liquid from the upper section, means for heating liquid in the lower section to produce a vapour for passage through the filter in dependence on a pressure differential generated across the filter such that a portion of the vapour creates a pocket of vapour in the lower section below the filter and the remaining portion passes through the filter and is at least partially condensed in the upper section, and means for controlling the size of the vapour pocket while maintaining a volume of liquid to be heated in the lower section.

According to a further aspect of the invention, there is provided a method of purifying a liquid comprising providing a first volume of liquid to be heated by heating means submerged in the liquid to generate a vapour, providing a second volume of liquid to be heated by the vapour, and providing a barrier permeable to the vapour between the first and second volumes such that a vapour pocket is created below the barrier without exposing the heating means.

According to yet another aspect of the invention, there is provided a method of producing purified water comprising providing a container having a lower section and an upper section separated by a filter, an inlet for introducing water to be purified to the lower section, an outlet for withdrawing purified water from the upper section, heating means in the lower section for heating water in the lower section to generate steam for passing through the filter to re-condense in and heat the water in the upper section, and controlling the generation of steam so that a steam pocket is formed in the lower section below the filter without exposing the heating means.

Preferred embodiments of the invention will now be described with reference to the accompanying drawings.

### BRIEF DESCRIPTION OF THE DRAWINGS

FIGS. 1 and 2 are diagrammatic views of a first embodiment of apparatus for carrying out the method according to the invention showing the upper and lower water levels in the upper section for controlling the inflow of water to the lower section;

FIG. 3 is a diagrammatic view, similar to FIGS. 1 and 2, showing the operation of the apparatus for heating water in the upper section with steam generated in the lower section;

FIGS. 4 to 6 are diagrammatic views, similar to FIGS. 1 to 3, showing a second embodiment of apparatus for carrying out the method according to the invention; and

FIG. 7 is a diagrammatic view showing a modification to the apparatus of FIGS. 1 to 3.

### DETAILED DESCRIPTION OF THE EXEMPLARY EMBODIMENTS

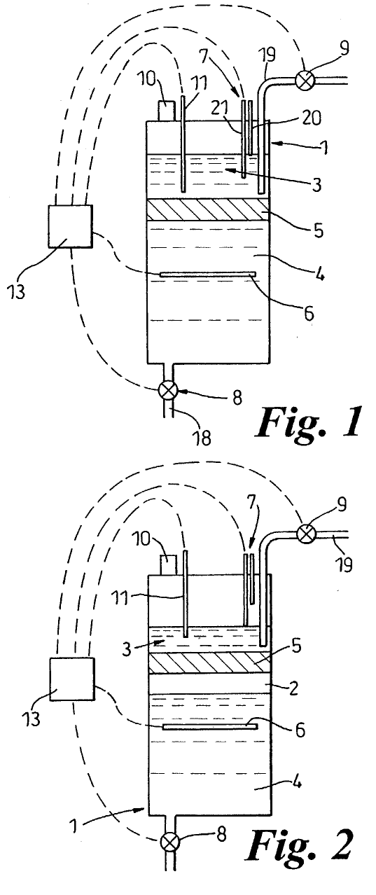

Referring first to FIGS. 1 and 2 of the drawings, there is shown water purification apparatus comprising a container 1 divided into an upper section 3 and a lower section 4 by a filter 5.

A heater 6 is disposed in the lower section 4 below the filter 5. In this embodiment, the heater 6 is electrically powered and comprises a single heating element having a power of 1500 watts. The power of the heater 6 may be varied by adjusting the voltage applied to the heating element. Alternatively or additionally, the heater 6 may comprise a plurality of heating elements that can be switched on or off separately or in combination to vary the power of the heater 6.

An inlet conduit 18 equipped with a valve 8 is provided for introducing water into the lower section 4 and an outlet conduit 19 having a valve 9 is provided for drawing water off from the upper section 3. Means 7 is provided for monitoring the level of water in the upper section 3 and comprises a pair of sensors 20,21. The sensor 20 detects the water level when the apparatus is filled prior to heating the water, and the sensor 21 detects a minimum water level in response to water being drawn off through the outlet conduit 19.

The apparatus is further provided with a pressure relief valve 10 in the upper section 3 for releasing excess pressure, a temperature sensor 11 for monitoring water temperature in the upper section 3 and a microprocessor control system 13 for controlling operation of the apparatus in response to signals received from the level sensors 20,21 and temperature sensor 11.

The pressure relief valve 10 is operable to open and close automatically to relieve excess pressure in the upper section 3 and remove undesirable volatile liquids allowing the steam transfer process to continue. The temperature sensor 11 is operable to provide a signal representative of the water temperature to the control system 13 when the water temperature is sufficient for purified water to be drawn off from the upper section 3.

In operation, control system 13 opens inlet valve 8 and water flows into the lower section 4 of the container 1, up through the filter 5 and into the upper section 3. The inlet valve 8 is closed by the control system 13 in response to a signal from sensor 20 that the water level in the upper section has reached the desired level as shown in FIG. 1.

The heater 6 is then switched on by the control system 13 to heat the water in the lower section 4. The power of the heater 6 is chosen according to the volume of the water in the lower section 4 so that the temperature of the water can be rapidly increased to cause the water to boil. At this point, the water in the upper section 3 which is not directly heated by the heater 6 is still substantially below boiling point.

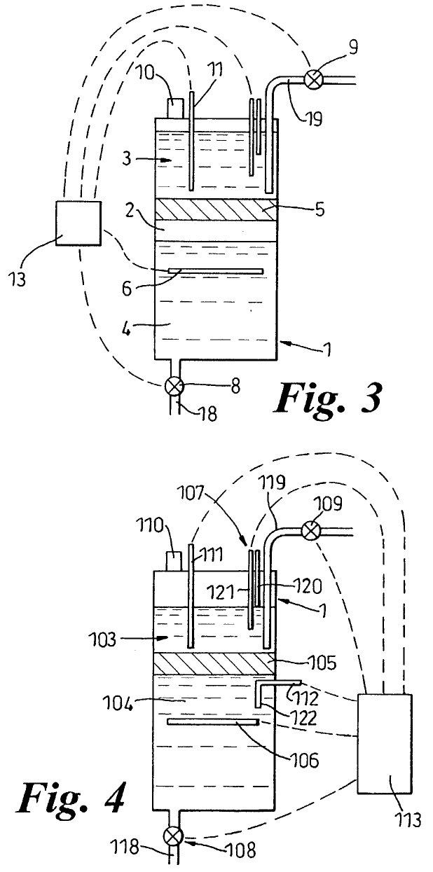

As the water boils, steam is formed and passes through the filter 5. The beating of the water in the lower section 4 increases the steam pressure below the filter 5 more rapidly than the steam pressure is released by steam escaping through the filter 5. Consequently, a steam pocket 2 forms below the filter 5 due to the differential pressure across the filter 5 as shown in FIG. 3.

The steam forced through the filter 5 re-condenses in, and warms rapidly, the water in the upper section 3 increasing the level of the water in the upper section 3 above the upper level set by sensor 20 on filling the container 1. Due to the vigorous boiling action below the filter 5, water in the lower section 4 may splash on the underside of the filter 5 and may be carried through the filter 5 by the steam.

Sensor 11 monitors the temperature of the water in the upper section 3 and, when the water is heated to a pre-determined temperature for a time sufficient to kill any bacteria, control system 13 opens valve 9 and allows purified water to be drawn off from the upper section 3 in pipe 19. The water drawn off may be used immediately for any desired purpose or may be stored, for example in a reservoir, for later use.

The water level in the upper section 3 falls as water is drawn off and, when the water level reaches the lower level determined by sensor 21, the control system closes outlet valve 9 and opens inlet valve 8 to allow water to be introduced to the lower section 4 in pipe 18. The boiling action is temporarily stopped by the introduction of cooler water and the container is re-filled to the upper level set by sensor 20 in the upper section 3. The cycle is then repeated to produce purified water in the upper section as previously described.

In accordance with the present invention, the position of the heater 6 and operation of the apparatus is such that a sufficient level of water is maintained in the lower section 4 to cover the heating element. More particularly, the steam pocket 2 is prevented from growing in size sufficiently to expose the heating element by matching the flow of incoming water to the mass flow of water in the form of steam through the filter to maintain the size of the steam pocket between upper and lower limits and keep the heating element covered by water in the lower section. In this way, overheating causing the heating element to burn out and resulting in premature failure of the heater 6 is avoided.

In quiet periods, the heater 6 is operable in a stand-by mode to maintain the water in the lower section 4 at a temperature of about 85° C. In this way, the water can be rapidly heated to re-start the process when there is a demand for purified water. During these quiet periods, the pressure differential across the filter 5 falls as steam is no longer being generated and the steam pocket 2 reduces in size. The steam pocket 2 does not disappear altogether and, when the process is re-started, the steam pocket 2 increases in size again as steam is generated to increase the pressure differential across the filter 5.

The above-described operation is suitable for a batch process for the production of purified water.

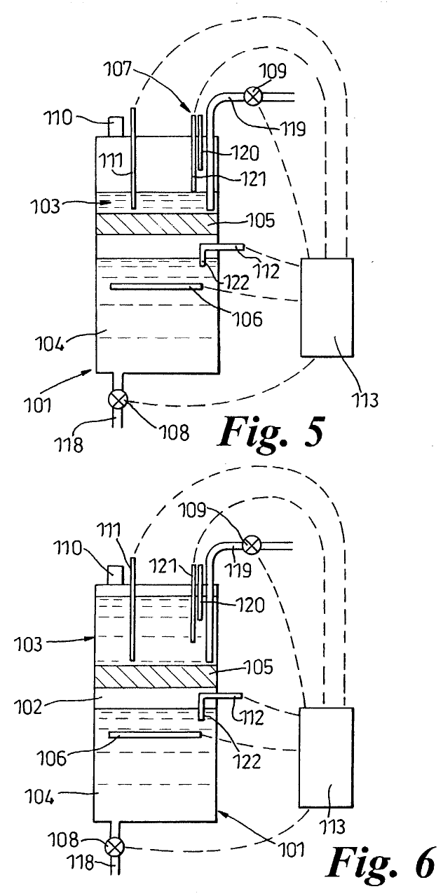

Referring now to FIGS. 4 to 6, a second embodiment of the invention is shown in which like reference numerals in the series 100 are used to indicate parts corresponding to the first embodiment.

In this embodiment, additional means 112 is provided including a sensor 122 for monitoring the level of water in the lower section and thus the size of the steam pocket 102. The control system 113 receives a signal from the sensor 122 when the level of the water in the lower section 104 falls to a pre-determined minimum level and switches the heater 106 off or reduces the power of the heater 106.

The height of the pre-determined minimum water level is above the height of the heater 106 within the lower section 104. Switching the heater 106 off causes the rate at which steam is formed in the lower section 104 to fall reducing the pressure differential across the filter 106 and preventing further increase in the size of the steam pocket 102.

At about the same time, the control system 113 opens valve 108 to allow more water to be introduced into the lower section 4 and shortly after switches the heater 106 back on again. By switching the heater on and off in response to the water level in the lower section 104 and by introducing water into the lower section, the size of the steam pocket 102 can be controlled so that the heater 106 is always surrounded by water when switched on.

The control system 113 may be operable to vary the power output of the heater 106 rather than switch the heater on and off during a heating cycle so as to control the size of the steam pocket 102 and maintain the level of water in the lower section 104 within a pre-determined range after the initial filling of the container.

When the water in the upper section 103 is heated to a pre-determined temperature for a time sufficient to kill any bacteria, the valve 109 is opened by the control system 113 in response to a signal from temperature sensor 111 allowing purified water to be drawn off from the upper section 103 in conduit 119. Purified water drawn off from the upper section 103 may be used immediately or transferred to a reservoir (not shown) for storage until required for end use.

The control system 113 is operable to close the valve 109 if the water level in the upper section falls to the minimum level in response to a signal from sensor 121 and open valve 108 to introduce cooler water into the lower section 104.

By controlling the valves 108,109 and the heater 106, the apparatus can be operated to provide either a continuous or a batch process for purifying water for any desired end use.

In quiet periods, the heater 106 is operable in a stand-by mode to maintain the water in the lower section 104 at a temperature of about 85° C. In this way, the water can be rapidly heated to re-start the process when there is a demand for purified water.

During these quiet periods, the pressure differential across the filter 105 falls as steam is no longer being generated and the steam pocket 102 reduces in size. The steam pocket 102 does not disappear altogether and, when the process is re-started, the steam pocket 102 increases in size again as steam is generated to increase the pressure differential across the filter 105.

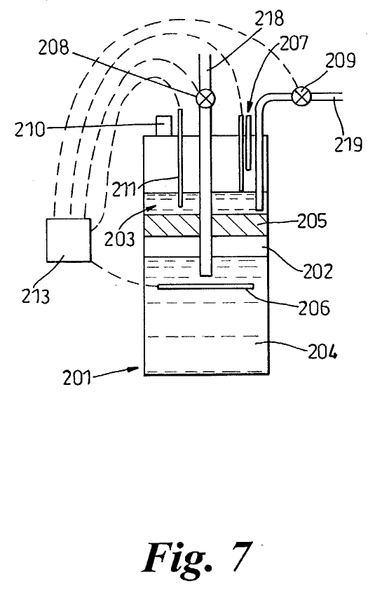

FIG. 7 shows a modification to the apparatus of FIGS. 1 to 3 in which like reference numerals in the series 200 are used to indicate corresponding parts. In this embodiment, inlet conduit 218 is arranged to pass through the upper section 203 whereby the incoming cold water to the lower section 204 is pre-heated by heat exchange with the water in the upper section 203. This enhances thermal efficiency of the process, and assists in the condensation of steam in the upper section 203. A similar modification may be employed in the apparatus of FIGS. 4 to 6.

In another modification (not shown), the pressure differential across the filter may be adjusted to control the size of the stream pocket by controlling the pressure in the upper section and/or the lower section. For example, valves may be provided for releasing pressure in the upper section and/or lower section under the control of the control system in response to the water level in the lower section.

It will be understood that the invention is not limited to the embodiments above-described and that various modifications can be made without departing from the concept of controlling the size of the steam pocket generated to prevent the heater being exposed above the water level in the lower section.

I claim:

1. A liquid purification method which comprises providing a container having a lower section and an upper section separated by a filter, supplying liquid to the lower section, heating said liquid in the lower section to produce a vapour for passage through the filter to heat liquid in the upper section, wherein a pressure differential is generated across the filter between the lower section and the upper section such that a portion of said vapour creates a pocket of vapour in the lower section below the filter and the remaining portion passes through the filter and is at least partially condensed in the upper section, and controlling the size of said vapour pocket while maintaining a volume of liquid to be heated in the lower section, and withdrawing liquid from the upper section.

2. A method according to claim 1 wherein said liquid is water and water in the upper section above the filter is heated by steam generated in the lower section that passes through the filter and condenses in the water above the filter.

3. A method according to claim 2 wherein the filter is bathed in steam.

4. A method according to claim 2 wherein a heater is positioned in the lower section for directly heating the water below the filter and the size of said steam pocket below the filter is controlled so the heater is covered by the water in the lower section.

5. A method according to claim 4 wherein the size of the steam pocket is controlled to match the flow of incoming water to the lower section to the mass flow through the filter once a desired size of steam pocket has been achieved.

6. A method according to claim 5 wherein the rate of mass flow through the filter is dependent on a pressure differential across the filter.

7. A method according to claim 6 wherein the pressure differential is controlled by adjusting the power of the heater.

8. A method according to claim 7 wherein increasing the power of the heater accelerates boiling of said water in the lower section and thus the rate of steam generation which in turn increases the pressure below the filter.

9. A method according to claim 7 wherein reducing the power of the heater slows down boiling of the water in the lower section and thus the rate of steam generation which in turn reduces the pressure below the filter.

10. A method according to claim 6 wherein the pressure differential across the filter is controlled in response to the water level in the lower section.

11. A method of purifying a liquid comprises providing a first volume of liquid to be heated by heating means submerged in the liquid to generate a vapour, providing a second volume of liquid to be heated by the vapour, and providing a barrier permeable to the vapour between the first and second volumes such that a vapour pocket is created below the barrier without exposing the heating means.

12. A method of producing purified water comprising providing a container having a lower section and an upper section separated by a filter, an inlet for introducing water to be purified to the lower section, an outlet for withdrawing purified water from the upper section, heating means in the lower section for heating water in the lower section to generate steam for passing through the filter to re-condense in and heat the water in the upper section, and controlling the generation of steam so that a steam pocket is formed in the lower section below the filter without exposing the heating means.

13. A batch process for purifying water by the method according to claim 2 wherein the container is initially filled with water to an upper level in the upper section and, when the water in the upper section is heated to a pre-determined temperature by steam passing through the filter from the lower section, the water in the upper section may be drawn off to a lower level at which water is introduced to the lower section.

14. A batch process according to claim 13 wherein incoming water flow is on/off in dependence on the upper and lower levels of water in the upper section and the size of the steam pocket in the lower section is controlled between upper and lower limits to accommodate the transfer of water in the form of steam vapour passing through the filter from the lower section to the upper section and ensure the heating element remains covered by water in the lower section.

15. A continuous process for purifying water by the method according to claim 2 wherein the container is initially filled to a pre-determined level in the upper section and, when the water in the upper section is heated to a pre-determined temperature by steam passing through the filter from the lower section, the water in the upper section may be drawn off and water introduced to the lower section.

16. A continuous process according to claim 15 wherein incoming water flow is continuous in dependence on the rate water is drawn off from the upper section and the size of the steam pocket in the lower section is controlled between upper and lower limits to accommodate the transfer of water in the form of steam vapour passing through the filter from the lower section to the upper section and ensure the heating element remains covered by water in the lower section.

17. Apparatus for carrying out the method according to claim 1 comprising a container having a lower section and an upper section separated by a filter, an inlet for supplying liquid to the lower section, an outlet for withdrawing liquid from the upper section, means for heating liquid in the lower section to produce a vapour for passage through the filter in dependence on a pressure differential generated across the filter such that a portion of the vapour creates a pocket of vapour in the lower section below the filter and the remaining portion passes through the filter and is at least partially condensed in the upper section, and means for controlling the size of the vapour pocket while maintaining a volume of liquid to be heated in the lower section.

18. Apparatus according to claim 17 including control means operable to permit liquid to be withdrawn from the upper section in response to the temperature of the liquid in the upper section and to add liquid to the lower section in response to the liquid level in the upper section.

19. Apparatus according to claim 18 wherein the heating means is in direct contact with liquid in the lower section and the control means is operable to control the heating means in response to the water level in the lower section.

20. Apparatus according to claim 18 wherein incoming liquid to the lower section is pre-heated by heat exchange with liquid in the upper section.
